(19) United States
(12) Patent Application Publication
(10) Pub. No.: US 2026/0198464 A1
(43) Pub. Date: Jul. 16, 2026

(54) A STRUCTURE FOR PROMOTING CORAL GROWTH IN SITU

(71) Applicant: Kirk Dotson, Fort Lauderdale, FL (US)

(72) Inventor: Kirk Dotson, Fort Lauderdale, FL (US)

(21) Appl. No.: 19/127,767

(22) PCT Filed: Oct. 3, 2023
(86) PCT No.: PCT/US2023/075807

§ 371 Date: May 7, 2025

Related U.S. Application Data
(60) Provisional application No. 63/423,201, filed on Nov. 7, 2022.

(51) Int. Cl. A01K 61/73

(52) U.S. Cl. CPC A01K 61/73

(57) ABSTRACT

A system for promoting coral growth at the reef includes a base. A piece of coral is disposed on the base. A plurality of pins are anchored to the base about the coral; each pin of the plurality of pins being biodegradable in seawater. The number of pins, the height of each pin and the spacing between adjacent pins being sufficient to prevent a parrotfish from accessing the coral.

### CROSS-REFERENCE TO RELATED APPLICATION

This application claims the benefit of and priority from U.S. provisional application No. 63/423,201 filed on Nov. 7, 2022 and entitled A STRUCTURE FOR PROMOTING CORAL GROWTH IN SITU. The contents of the above applications are hereby incorporated herein by reference in full.

### BACKGROUND OF THE INVENTION

The present invention is directed to a system for promoting coral growth, and more particularly, for protecting coral from predatory animals for a time period to enable sufficient growth, and reducing the need for maintenance of the system, particularly when the need for the system no longer exists.

Coral reefs are a living organism, and they are dying. There is great effort to replace the dying coral with new coral. One method and structure is to replant coral with coral grown on shore. However, this coral requires time to take root and develop sufficient maturity to prevent its dying from predators; such as parrotfish. As is known in the art, parrotfish eat coral and the things that live within the coral. Mature coral can withstand this symbiotic relationship. However, the parrot fish destroy the less mature coral; killing them off before they reach maturity and are sufficiently sized to survive a parrotfish attack.

It is known in the art to build a fence, tent or mesh cage around the coral preventing parrot fish from approaching the coral while the coral takes root and matures. While this prior art solution has been satisfactory, these fences are made from lasting materials such as PVC, steel or bamboo, and are arrayed about the coral. They keep the parrotfish away, but promote macroalgae, which is harmful to coral and other fauna and flora associated with a coral reef; destroying the eco system. As a result, these prior art barriers require man hours to clean the fence during use and then remove the fence once the coral has sufficiently matured. Additionally, once the cage was removed the now exposed coral was heavily predated.

Accordingly, a system and method which overcomes the shortcomings of the prior art is desired.

### SUMMARY OF THE INVENTION

A system for promoting coral growth at the reef includes a base. A piece of coral is disposed on the base. A plurality of pins are anchored to the base about the coral; each pin of the plurality of pins being biodegradable in seawater. The number of pins, the height of each pin and the spacing between adjacent pins being sufficient to prevent a parrotfish from accessing the coral.

### BRIEF DESCRIPTION OF THE DRAWINGS

The features and advantages of the present invention will become more readily apparent from the following detailed description of the invention in which like elements are labeled similarly and in which:

FIG. 1 is a side elevational view of the system for promoting growth of coral constructed in accordance with the invention;

FIG. 2 is a top plan view of the system for promoting growth of coral constructed in accordance with the invention;

FIG. 3 is a is a graph showing the relationship between destructive effect of parrotfish on the coral and the degradation of the pins constructed in accordance with the invention over time; and

FIG. 4 is a top plan view of the invention without the coral.

### DETAILED DESCRIPTION OF THE PREFERRED EMBODIMENTS

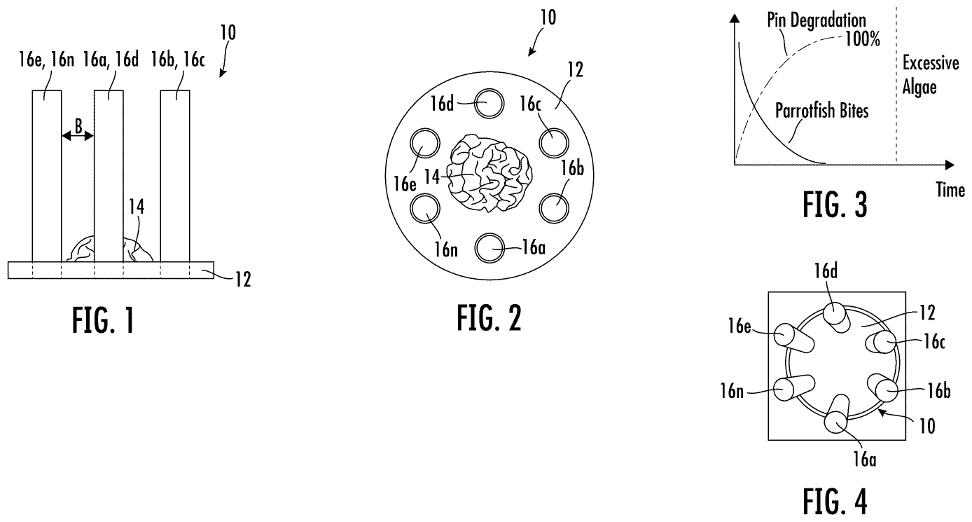

Reference is made to FIGS. 1 and 2 and 4 in which a system, generally indicated as 10, for protecting juvenile corals and coral micro fragments moved from laboratories to the ocean and other natural bodies of water to promote growth in situ of coral is provided. Like numerals are used to indicate like structure.

System 10 has a base 12. In a preferred embodiment base 12 is made from a non-biodegradable, non-leaching substance. A coral fragment 14 is disposed on base 12. In a preferred non limiting embodiment coral fragment 14 is anchored to base 12. A plurality of pins 16a-16n are disposed at spaced intervals on base 12 about coral fragment 14 to circumscribe coral fragment 14.

In a preferred non limiting embodiment pins 16 are anchored to base 12. Pins 16 are biodegradable in seawater, and preferably formed as thin tubes or straws, but may be formed as solid rods of a diameter to best protect the coral over the desired time period. However, in the preferred non limiting embodiment, thin tubes and straws have less material than solid rods, reducing the amount of material used, reducing the weight of the straws and the system overall during handling, and because more surface is exposed to the seawater, reduces the time needed to biodegrade. In a preferred nonlimiting embodiment a wall of each straw pin 16 has a thickness of between 0.2 mm and 1 mm.

In a preferred non limiting embodiment, the pins 16 are formed from polyhydroxyakanoate (“PHA”) such as PHADE® straws manufactured by WinCup, by way of non-limiting example or polycaprolactone (“PCL”); both materials being biodegradable in seawater. Base 12 is preferably made of cement or concrete to provide sufficient density/weight to anchor system 10 in place. The size and spacing of respective pins 16 are chosen to promote biodegrading of pins 16 in a preferred time period during which coral fragment can grow, and there is insufficient time for algae to grow on respective pins 16.

For the coral 14 to grow it must not only be protected from predators for a period of time, but it must also be exposed to seawater flow to access nutrients in the seawater while also preventing sedimentation. In a preferred non limiting embodiment respective pins 16 are positioned across a gap B of about 1.5 to 5 cm from each other. It is believed that a gap less than about 1.5 cm will prevent sufficient seawater flow to nurture coral fragment 14 and anything greater than about 5 cm will enable parrotfish to swim therebetween accessing the coral. It should be noted that gap B need not be uniform about coral fragment 14; only that no one gap B be substantially less than 1.5 cm or greater than 5 cm. Also, in a preferred embodiment each pin 16 extends between 7 cm and 20 cm from base 12 to discourage parrotfish from accessing coral fragment from above. While it is also possible to put a top across pins 16, preferably the structure does not have a top because it would block sunlight and, if made of PHA, fragments of the top may fall on top of the coral as the top disintegrates. Therefore, in the preferred embodiments, pins long enough to prevent predators from entering from the top are preferred.

In a preferred embodiment, pins 16 undergo surface erosion to biodegrade in between 1.5 months and a year; and in a preferred embodiment in between 3 and 6 months. In this way the system 10 surfaces biodegrade at a rate faster than algae growth, discouraging the growth of algae on the pins 16 while lasting sufficiently long enough for coral fragment 14 to mature. It also removes the need for maintenance once in place.

It is believed that avoiding obstacles for fish in the wild can be a learned behavior. Therefore, as parrotfish encounter system 10 they are discouraged and will learn that they should try other food sources which are more easily accessed. Their attempts over time to access a protected coral fragment 14 will decline over time while allowing the coral fragment 14 to acclimate to the in situ environment. Therefore, as seen in FIG. 3 this has the effect that over time, pins 16 will degrade while fish attacks will decrease as a result of new learned behavior. This results in a learned behavior not found in the prior art. As a result reduces coral mortality to between 0 and 10 percent, a major reduction compared to no protection at all, and the parrotfish do not aggressively return once the system has dissolved.

Assembly of system 10 is done on shore. In this way the amount of labor needed to be done in the more difficult underwater environment is minimized.

By providing a barrier in accordance with the invention as described above, the system forms a barrier about the piece of coral sufficient to allow seawater to pass therethrough and prevent animals to pass therethrough. This approach lends itself to being employed on a massive scale for restoration efforts from the Florida keys to the Australian great barrier reef. While parrotfish are the focus for this structure, it should be noted that they are just one exemplary predator species, and the inventive structure will also prevent predation from less destructive corallivores such as sea urchins, butterflyfish, and snails.

The solution is an inexpensive solution to the parrotfish problem which can be massively reproduced while reducing the labor needed to maintain the system once in place. A fence of biodegradable material protects the coral and disintegrates within a few months, specifically, after the parrotfish group stop targeting the coral transplants, but before excessive algae growth on the structure.

Additionally, as result of the prolonged exposure in the above structure, the coral fragments become indistinguishable from corals native to the ocean. Some researchers think that lab corals look, smell, or taste differently than native ocean corals and that this attracts the attention of parrotfish. This structure allows the lab coral to acclimate before the device disintegrates. Therefore, regardless of whether parrotfish target corals because of territoriality or because of the lack of acclimatization, the above described structure covers both possibilities.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A system for promoting coral growth at a reef includes:
a base;
a piece of coral disposed on the base; and
a plurality of pins anchored to the base about the piece of coral; each pin of the plurality of pins being biodegradable in seawater; and the plurality of pins forming a barrier about the piece of coral sufficient to allow seawater to pass therethrough and prevent animals to pass therethrough.

2. The system of claim 1, wherein at least one pin is formed as a tube or straw.

3. The system of claim 1, wherein each pin of the plurality of pins is spaced from an adjacent pin by no less than 1.5 cm.

4. The system of claim 1, wherein each pin of the plurality of pins is spaced from an adjacent pin by no more than 5 cm.

5. The system of claim 1, wherein at each pin of the plurality of pins extends from the base for a distance of no less than 7 cm.

6. The system of claim 1, wherein each pin of the plurality of pins extends from the base for a distance of no more than 20 cm.

7. The system of claim 1, wherein at least one pin is formed of polyhydroxyakanoate.

8. The system of claim 1, wherein the base is formed of at least one of concrete and cement.

9. The system of claim 1, wherein at least one pin is formed as a tube or straw; each pin of the plurality of pins is spaced from an adjacent pin by no less than 1.5 cm and by no more than 5 cm; at least one pin of the plurality of pins extends from the base for a distance of no less than 7 cm and no more than 20 cm; and at least one pin is formed of polyhydroxyakanoate; and the base is formed of concrete.
